(19) United States
(12) Patent Application Publication
(10) Pub. No.: US 2009/0284766 A1
(43) Pub. Date: Nov. 19, 2009

(54) Image Synthesis Method, Print System and Image Synthesis Program

(76) Inventor: Shigeru Yajima, Tokyo (JP)

Correspondence Address: Cameron Kerrigan;Squire, Sanders & Dempsey L.L.P., Suite 300, One Maritime Plaza, San Francisco, CA, 94111, US

(21) Appl. No.: 12/405,907

(22) Filed: Mar. 17, 2009

(30) Foreign Application Priority Data
May 13, 2008 (JP) JP2008-125931

(51) Int. Cl. H04N 1/60; G06K 9/36

(52) U.S. Cl. 358/1.9; 382/166

(57) ABSTRACT

An image synthesis method including the steps of: executing a lossless compression of first image data of a first image in a pixel unit by utilizing a table which correlates coordinate values expressed in m bits in a color space to index values expressed in n bits that is smaller than the m bits; executing a lossless compression of second image data of a second image in a pixel unit by utilizing the table used to execute the lossless compression of the first image data; generating compressed synthetic image data by synthesizing the compressed first image data and the compressed second image data in a pixel unit; and decompressing the compressed synthetic image data in a pixel unit by utilizing the table to generate synthetic image data in which each pixel of the synthetic image data is expressed as a coordinate value in the color space.

### CROSS-REFERENCE TO RELATED APPLICATION

The present application is based on Japanese Patent Application No. 2008-125931 filed with Japanese Patent Office on May 13, 2008, the entire content of which is hereby incorporated by reference.

### BACKGROUND OF THE INVENTION

1. Technical Field

The present invention relates to an image synthesis method, a print system, and an image synthesis program, particularly relates to an image synthesis method for synthesizing a color multi-valued image, a print system for printing an image synthesized in the image synthesis method and an image synthesis program.

2. Description of Prior Art

In recent years, richer contents, smaller lot, and quicker-delivery are desired in on-demand-printing markets and variable printing markets, such as direct mail, a label, POP and a report. The printer, which outputs those printed materials, is also becoming speedier each year. However, it abundantly requires considerable time to generate a raster image for high-resolution full color printing from the print data in which pictures and photographs are used. Therefore, in case when a page contains a content that requires complicated image processes, the generation capacity of raster image may become lower than printing capability.

As a solution to this problem, there are methods called a form overlay method and a variable data print method. The variable data print method is a method that began to attract attention in recent years. PPML (Personalized Print Markup Language) and PPML/VDX (PPML/Variable Data Exchange) of an industry standard are used as a variable data print language. This variable data print method has a reusable object and a non-reusable object as a minimum constitutional unit. The reusable object is a common part used for a plurality of times in a plurality of pages or on the same page. The non-reusable object is a variable part used for only once in a text. Layout information in the print data clearly defines whether each variable object is a reusable object or is a non-reusable object. How a variable object group will be laid out in each page is described in the layout information.

Generally, functions of an image process in the printer (or print system), which supports the variable data print language, can roughly be divided into a raster image generation (rasterization) and an image synthesis (page layout). In rasterization, image data is created by executing bit map developments of the variable objects. In that case, since the reusable objects are used over a plurality of pages, the reusable objects are cached into a memory, such as a memory and a hard disk. In the page layout, the variable objects rasterized are synthesized on a page buffer based on the layout information.

When performing the cache of the rasterized reusable objects into memory, it is common to perform a data compression by a certain method in order to conserve the system resources to be used. As a data compression method, there are a variable-length coding method represented by JPEG and ZIP, and a fixed-length coding method as disclosed in Japanese Unexamined Patent Publication No. H07-336675.

The variable-length coding method is adopted in respect to high compression efficiency, or from the point of a diffusion rate. However, in case when compressing image data by a variable-length coding method, since synthesizing in a compressed state is impracticable, there is a need to synthesize the image data once a decoding has been performed. That is, it implies that the decoding process occurs for the number of times that the reusable object is synthesized. As a result, in the variable-length coding method, there is a problem that page layout time delays proportional to the rate of the number of times of use and of the area ratio of the reusable object.

As one method in solving this problem, there is a technique of synthesizing the image to which the block compression was performed as disclosed in the Japanese Patent Publication. In this method, since the decoding process is not required, the synthesis is done in the compressed state and the data volume handled in the synthesis process can be small when compared to the data volume in an uncompressed state after the decoding, the shorter synthesis process time can be expected.

However, the block compression is a kind of lossy compression and has the problem that degradation of an image occurs at the time of decoding. Therefore, application of this method is difficult in respect to the demand of high-definition printing.

### SUMMARY

The present invention has one perspective addressing the above problem, and the major object of the present invention according to the perspective is to provide an image synthesis method, a print system and an image synthesis program that can efficiently synthesize the images. One of more specific objects of the present invention according to the perspective is to achieve the efficient synthesize of the images while preventing the degradation of the image at the time of decoding.

To achieve at least one of the above-mentioned objects or other objects, an image synthesis method reflecting one aspect of the present invention including the steps of:

executing a lossless compression of first image data of a first image in a pixel unit by utilizing a table which correlates coordinate values expressed in m bits in a color space to index values expressed in n bits that is smaller than the m bits;

executing a lossless compression of second image data of a second image in a pixel unit by utilizing the table used to execute the lossless compression of the first image data;

generating compressed synthetic image data by synthesizing the compressed first image data and the compressed second image data in a pixel unit; and

decompressing the compressed synthetic image data in a pixel unit by utilizing the table to generate synthetic image data in which each pixel of the synthetic image data is expressed as a coordinate value in the color space.

In the image synthesis method reflecting the other aspect of the present invention, the above-mentioned table can be established in the steps of executing the lossless compressions of the first image data of the first image and the second image data of the second image in a pixel unit.

The image synthesis method reflecting the other aspect of the present invention further includes a step of comparing the number of the index values to be used for expressing a target images of synthesis with a predetermined threshold value, wherein the lossless compressions, the generation of the compressed synthetic image data, and the decompression of the compressed synthetic image data in a pixel unit are executed in cases where the number of the index values is not greater than the threshold value.

The image synthesis method reflecting the other aspect of the present invention further includes a step of comparing the number of pixels each of which has a specific attribute value in a target image of synthesis with a predetermined threshold value, wherein the lossless compressions, the generation of the compressed synthetic image data, and the decompression of the compressed synthetic image data in a pixel unit are executed in cases where the number of pixels having the specific attribute value is not greater than the threshold value.

### BRIEF DESCRIPTION OF THE DRAWINGS

These and other objects, advantages and features of the invention will become apparent from the following description thereof taken in conjunction with the accompanying drawings in which:

FIG. 1 illustrates a diagram showing a configuration of a variable print system related to a first embodiment of the present invention;

FIG. 2 illustrates a flow chart showing the entire flow of the variable print system related to the first embodiment of the present invention;

FIG. 3 illustrates a flow chart showing a common coding process in a printer controller related to the first embodiment of the present invention;

FIG. 4 illustrates a flow chart showing a compression synthesis process in the printer controller related to the first embodiment of the present invention;

FIG. 5 illustrates a flow chart showing a common decoding process in the printer controller related to the first embodiment of the present invention;

FIG. 6 illustrates a diagram showing a concrete example of a common coding table related to the first embodiment of the present invention;

FIG. 7 illustrates a schematic diagram showing a common coding process related to the first embodiment of the present invention;

FIG. 8 illustrates a schematic diagram showing a compression synthesis process related to the first embodiment of the present invention;

FIG. 9 illustrates a schematic diagram showing the common coding process related to the first embodiment of the present invention.

FIG. 10 illustrates a diagram showing a configuration of a variable print system related to a second embodiment of the present invention;

FIG. 11 illustrates a flow chart showing the entire flow of the variable print system related to the second embodiment of the present invention;

FIG. 12 illustrates a flow chart showing an application determining process in a printer controller related to the second embodiment of the present invention;

FIG. 13 illustrates a flow chart showing the application determining process in the printer controller related to a third embodiment of the present invention;

FIG. 14 illustrates a flow chart showing the entire flow of the variable print system related to a fourth embodiment of the present invention;

FIG. 15 illustrates a diagram showing a configuration of a conventional variable print system;

FIG. 16 illustrates a flow chart showing the entire flow of the conventional variable print system; and

FIG. 17 illustrates a flow chart showing the synthesis process in a conventional printer controller.

### DETAILED DESCRIPTION OF THE PREFERRED EMBODIMENTS

As described in the background art, in order to increase the efficiency of a variable printing, methods for classifying an object into a reusable object and a non-reusable object and for executing cache of the reusable object to a memory are used. However, in order to conserve system resources, the reusable object needs to be compressed, and a variable-length coding method is usually adopted for high compression efficiency or for a diffusion rate.

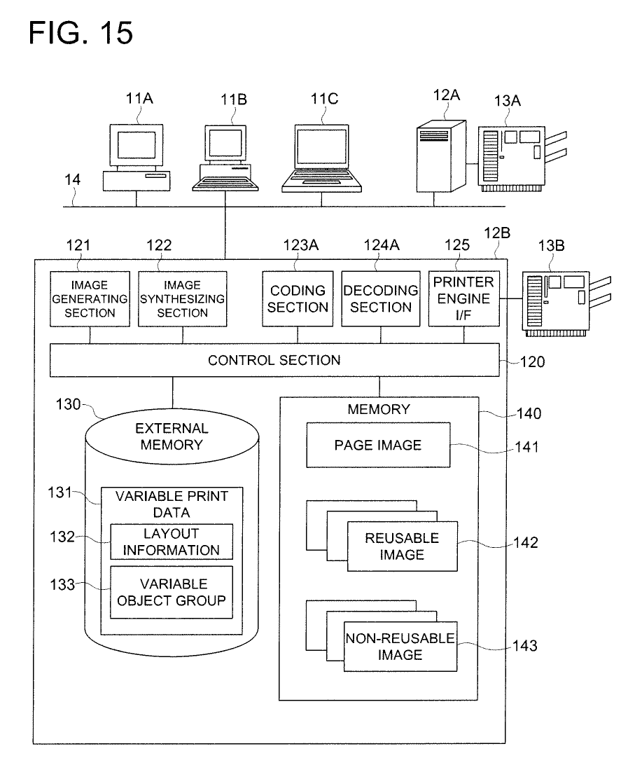

Hereafter, a configuration and an operation of a conventional variable print system are outlined in reference to FIGS. 15-17.

As shown in FIG. 15, the conventional variable print system is roughly configured by client PCs (11A-11C), printer controllers (12A, 12B) and printers (13A, 13B). Each one of them is connected via a communication line.

The client PCs (11A-11C) are a personal computer in which printer driver software for creating print data is installed. The printer controllers (12A, 12B) receive the print data from the client PCs (11A-11C), create a raster image on each page and transmit the created raster image to the printers (13A, 13B). The printers (13A, 13B) print the raster image received from the printer controllers (12A, 12B) for each page.

The printer controllers (12A, 12B) are configured by a control section (120), an image generating section (121), an image synthesizing section (122), a coding section (123A), a decoding section (124A), printer engine I/F (125), an external memory (130) and a memory (140).

When printing print data by using the variable print system of the above-mentioned configuration, a user creates variable print data by using application software installed in the client PCs (11A-11C). The created variable print data is stored in the external memory (130) of a printer controller (12B) through a communication line (14).

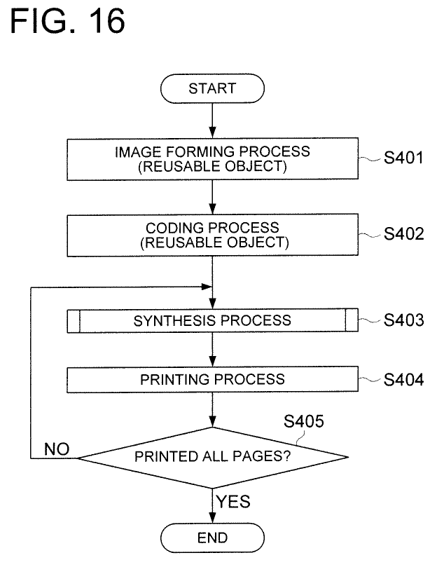

And as shown in a flow chart of FIG. 16, the control section (120) of the printer controller (12B) acquires layout information (132) from variable print data (131) stored in the external memory (130). From the layout information (132), the control section (120) generates a reusable image (142) included in a variable object group (133) with the image generating section (121) (S401). Next, after coding (compressing) the generated reusable image (142) by the coding section (123A), the coded reusable image (142) is cached to the memory (140) (S402). Next, the control section (120) acquires the layout information for one page, instructs the image synthesizing section (122) for the page layout for one page, and synthesizes an image based on the layout information by the image synthesizing section (122) (S403). Finally, the control section (120) sends a page image (141), to which the page layout was completed, to the printer (13B) via printer engine I/F (125), and performs printing and finishing processes in the printer (13B) (S404). The control section (120) determines whether a printout of all pages was completed (S405), and repeats the above-mentioned process until printout of all pages is completed.

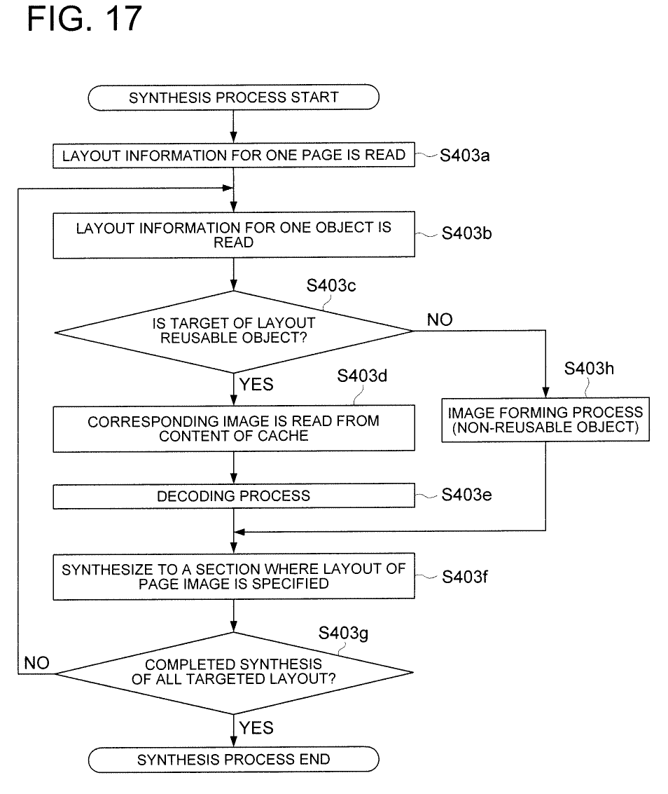

The details of the synthesis process of the above-mentioned step S403 are shown in the flow chart of FIG. 17. First, the image synthesizing section (122) reads in the layout information for one page, which was given by the control section (120) (S403a). Next, layout information for one object within the layout information for one page is read in (S403b). Next, whether the object is a reusable image (142) or a non-reusable image (143) is determined (S403c). In a case when the object is determined to be the reusable image (142), after a corresponding image is read from a cache (S403d) and the image is decoded based on the instruction given to the decoding section (124A) (S403e), the image is synthesized based on the layout information (S403f). On the other hand, in a case when the object is determined to be the non-reusable image (143), the image is synthesized based on the layout information (S403f) after the image was generated by the image generating section (121) (S403h). The image synthesizing section (122) determines whether the synthesis process of all targeted objects indicated by the layout information for one page is completed (S403g), and the above-mentioned process is repeated until the synthesis process of all targeted objects is completed.

Thus, in case when a variable-length coding method is used as a technique of the data compression, there is a problem that the page layout takes a considerable time. The reason is that since synthesizing images in a compressed state is impracticable, the reusable object is required to be synthesized each time after being decoded in Step S403e.

On the other hand, there is a fixed-length block truncation code as a fixed-length coding method. The technology related to the superposition edit (include synthesis) of the compressed images with the fixed-length block truncation code is disclosed in Japanese Unexamined Patent Publication No. H07-336675. The images can be synthesized in the compressed state. However, since a block truncation code method is a kind of lossy compression, there is a problem that the degradation of images occurring at the time of decoding.

In the Japanese Patent Publication, the block truncation code method compresses 4×4 pixels as one block in a block unit, and the synthesis process is realized by replacing the contents of the block. Therefore, in a case where the block boundary of two images, one of which will be the place where the image will be synthesized and the other of which will be a place where the image is synthesized from, are not aligned or in a case where only the specific pixel in a block is synthesized, since the contents of the block cannot be simply replaced, a complicated process, such as re-coding is necessary to be conducted after performing the synthesis of the content of the block. In this case, there is a problem that the page layout time will become long as well as the page layout time in the variable-length coding method.

Accordingly, in the embodiments of the present invention, a fixed-length coding method is used in order to solve the problem of the above-mentioned variable-length coding method. In order to solve the problem at the time of compressing data in the block unit, a coding (compression) in a pixel unit is performed. Further, in order to solve the problem of degradation of the image in lossy compression, the technique for performing a lossless compression using a common coding table is adopted.

With respect to the compression efficiency, the above-mentioned technique is inferior to the block compression, which is a type of the conventional variable-length coding method or lossy compression. However, the size of memories installed in a printer (or print system) is increasing with the recent low pricing of the memory. When considering the demand in faster/higher-definition image of a color print system of recent years, the improvement in speed of the page layout time or in the image degradation at the time of decoding are more important than the compression efficiency. From that, the above-mentioned technique can be concluded to be superior to the variable-length coding method or the block compression.

### FIRST EMBODIMENT

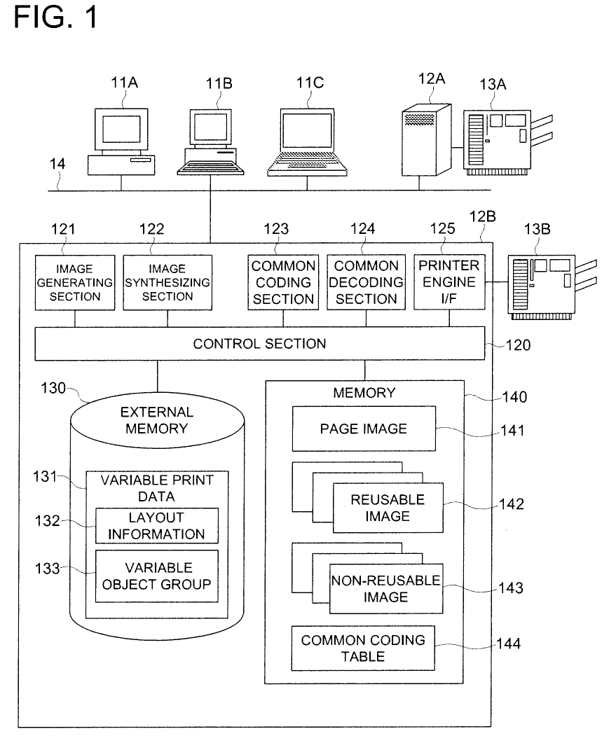

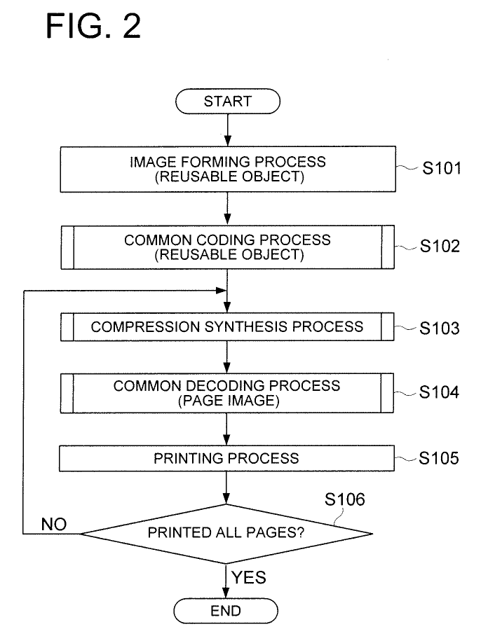

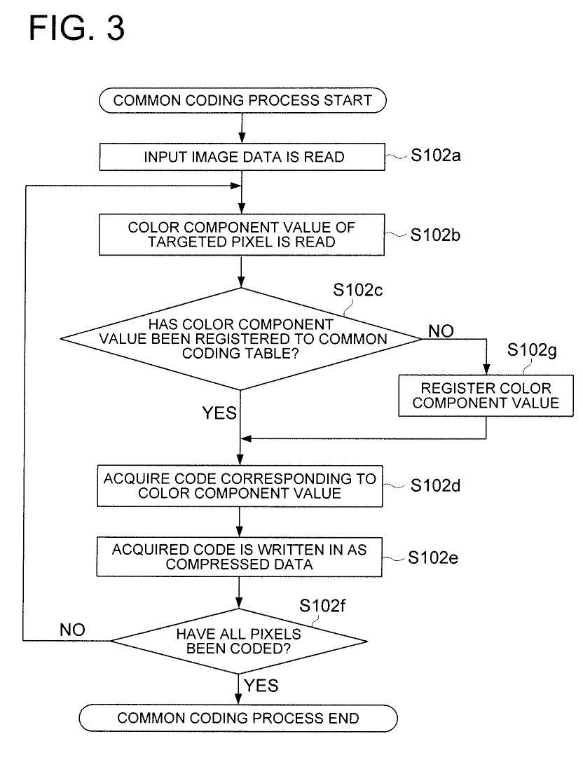

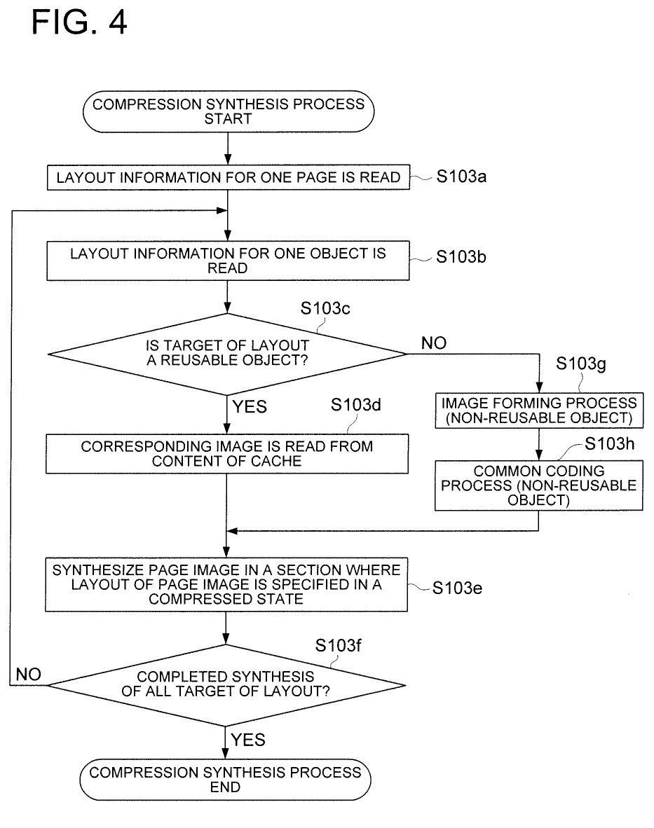

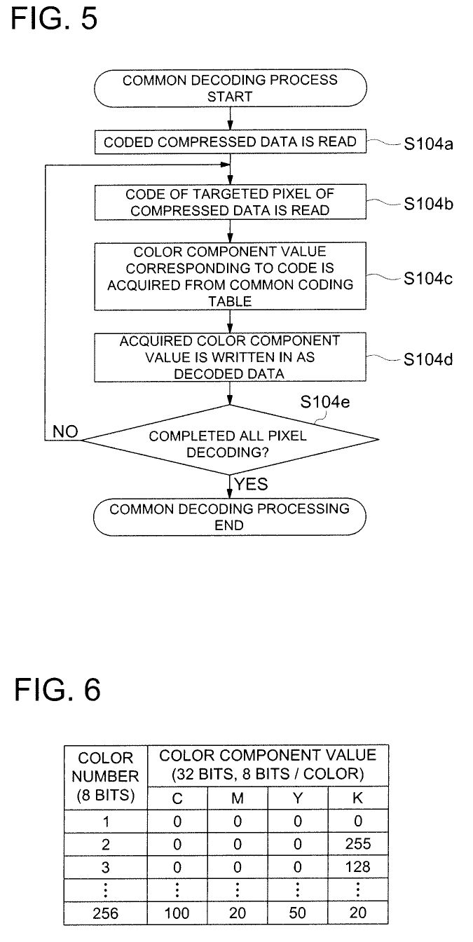

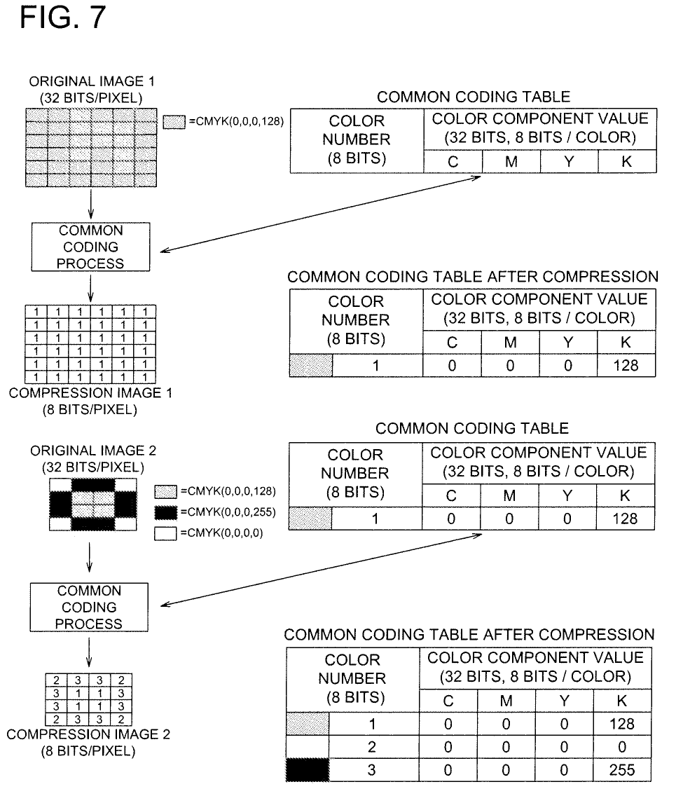

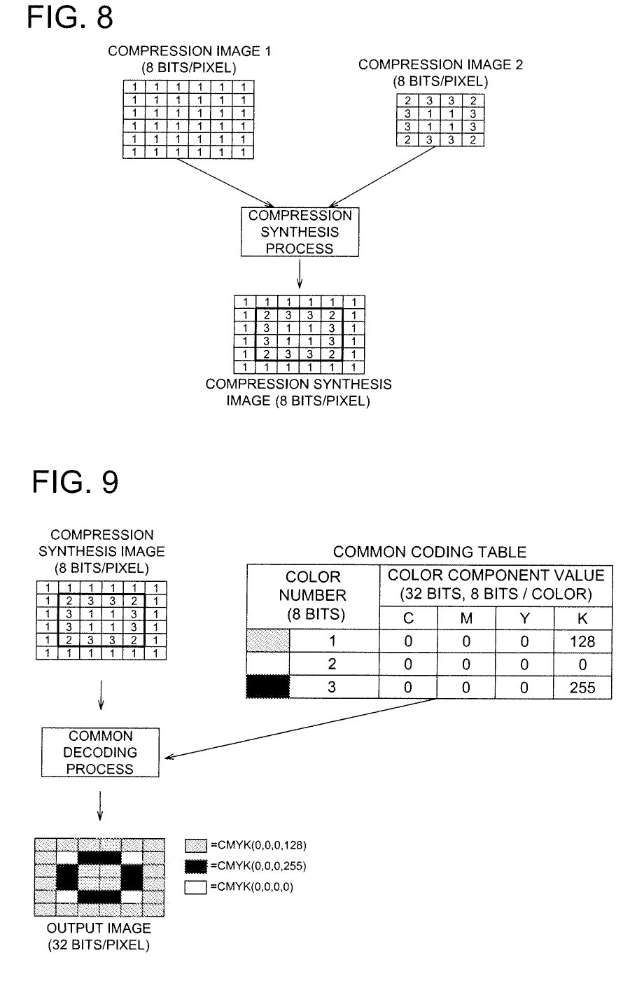

An image synthesis method, a print system and an image synthesis program related to a first embodiment of the present invention will be described in reference to FIG. 1-FIG. 9 in order to describe in further detail about the above-mentioned embodiment of the present invention. FIG. 1 illustrates a configuration of a variable print system of an embodiment of the present invention. FIG. 2 illustrates a flow chart showing the entire flow of the variable print system of this embodiment of the present invention. FIG. 3 illustrates a flow chart showing a common coding process in a printer controller. FIG. 4 illustrates a flow chart showing a compression synthesis process in the printer controller. FIG. 5 illustrates a flow chart showing a common decoding process in the printer controller. FIG. 6 illustrates a diagram showing a concrete example of the common coding table. FIG. 7 illustrates a schematic diagram showing the common coding process. FIG. 8 illustrates a schematic diagram showing the compression synthesis process. FIG. 9 illustrates a schematic diagram showing the common coding process.

Firstly, a coding by indexed colors used as the foundation of a compression technology related to an embodiment of the present invention will be described.

An indexed color is a kind of a color expression method of a bitmap image. The indexed color does not directly specify a color as coordinates in the color space for every pixel. The indexed color is widely known in general as a form that expresses the image by specifying the color number (index value) on the color definition table called a color map.

This method is a method, which focuses on the feature that the numbers of colors used in the image is limited in many cases when the image is dominantly configured with texts or illustrations. The colors being used are previously defined by the color numbers, such as “color number 1: red 100/green 50/blue/20, and color number 2: red4/green/90/blue50.” By specifying this color number as data for every pixel, data volume is reducible while having high color resolution. Such color expression is called “indexed color” or “pseudo color”. On the other hand, the color expression, which directly specifies a color as coordinates on the color space for every pixel, is called “true color” or “full color”.

The table for defining the actual corresponding color and color number in the indexed color is called “color map”, “color lookup table” or “color palette.” For example, in case when the size of the color map is for four colors, the data needed for each pixel is 2 bits, 4 bits for 16 colors, and 8 bits for 256 colors. Since 8 bits is frequently used as a unit of data processing of CPU (Central Processing Unit), the indexed color of 256 colors is most frequently used.

The indexed color is completely reproducible in an actual color from a color number. Thus, the indexed color can be considered as a kind of lossless compression. The decoding process for converting to an actual color from a color number can be performed with an easy implementation for only referring to the color map. Therefore, the decoding process will be realized by hardware (such as a video output circuit). In this case, since an image can be displayed only by transmitting a small volume of pixel data, high-speed drawing can be attained as long as the color map is written in the special section of the output circuit in advance.

Accordingly, this embodiment of the present invention focuses on the point that the fixed-length coding is possible by replacing the color component value (coordinate value on the color space) with the color number in a pixel unit, which is a feature of the indexed color. This embodiment of the present invention also focuses on the point that a lossless compression that can completely restore an actual color from an indexed color via a color map. In this embodiment of the present invention, the variable objects can be synthesized in the color number state (the state a color is represented by a color number), that is, in a compressed state, by converting all variable objects into indexed colors by using the common color map. In the case of variable printed materials, such as a ledger sheet and an invoice, the image is mainly configured by texts and graphics, such as a logo and a ruled line. There is a very high possibility that the numbers of colors being used is limited. Thus, this is a very suitable example. Hereafter, an example of a system, which realizes the above-mentioned technique, will be described.

FIG. 1 illustrates an example of the variable print system of this embodiment of the present invention. The variable print system of this embodiment of the present invention is configured by client PCs (11A-11C), printer controllers (12A, 12B) and printers (13A, 13B). Each of which is connected via a communication line (14).

The client PC (11A, 11B, or 11C) is a personal computer in which the printer driver software for creating print data is installed. The client PC (11A, 11B, or 11C) can be used for monitoring the processing state of the printer controller (12A or 12B) or for displaying the raster image created by the printer controller (12A or 12B) for each page.

The printer controller (12A or 12B) receives the print data from the client PC (11A, 11B, or 11C). The printer controller (12A or 12B) forms the raster image for each page using the external memory (130) and the memory (140). The formed raster image is transmitted to the printer (13A or 13B) through the printer engine I/F (125).

The printer (13A or 13B) prints the raster image for each page received from the printer controller (12A or 12B). The printer is not particularly limited. However, since the greatest advantage of the variable print system of this embodiment of the present invention is to make the high-speed printing of the high resolution color image possible, the printer is desired to be a model in which high-speed and high-definition printing is possible.

The communication line (14) connects the printer controllers (12A, 12B) with the client PCs (11A-11C) mutually with Ethernet. The print data generated in the client PC (11A or 11B) is transmitted to the printer controller (12A or 12B) through this communication line (14).

The printer controller (12A or 12B) is configured by a control section (120), an image generating section (121), an image synthesizing section (122), a common coding section (123), a common decoding section (124), the printer engine I/F (125), the external memory (130) and the memory (140). Namely, in this embodiment of the present invention, the common coding section (123) and the common decoding section (124) are provided in place of the coding section (123A) and the decoding section (124A) in the conventional configuration shown in FIG. 15. The color map (in this embodiment of the present invention, it is called a common coding table (144)) is memorized to a memory (140). Hereafter, each component will be described.

The control section (120) is configured by a memory and the like, such as CPU, ROM (Read Only Memory) and RAM (Random Access Memory). The control section (120) performs a flow control regarding the image formation of the print data (131), image synthesis of the print data (131) and transmission of the print data (131) to the printer (13A or 13B).

The image generating section (121) generates a raster image from the variable object group (133) stored in the external memory (130) by the instruction of the control section (120). There are a reusable image (142) to be used repeatedly within the print data and a non-reusable image (143) to be used only few times (for example, one time) within the print data in raster images (142, 143).

The image synthesizing section (122) performs image synthesis using the reusable image (142) and the non-reusable image (143), which are recorded in the memory (140), and generates a page image (141) for one page from the instruction of the control section (120).

The common coding section (123) codes (compresses) specified raster images (142,143) by referencing to the common coding table (144) from the instruction of the control section (120).

The common decoding section (124) decodes (expands) the page image (141) by referencing to the common coding table (144) according to the instruction of the control section (120).

The printer engine I/F (125) performs a control of the printer (13B) and a transmission of the page image (141) to the printer (13B).

The external memory (130) memorizes the print data created by the client PCs (11A, 11B, or 11C).

The variable print data (131) is configured by the layout information (132) and the variable object group (133).

The object information (identification name and whether it is the reusable object or not, and so on) of the variable object group (133) and the information (name of a layout object, origin of coordinates of where the object will be laid out, width/height of the object) related to the page layout are described in the layout information (132).

The variable object group (133) includes page description language data (PS (Post Script), PDF (Portable Document Format) and EPS (Encapsulated Post Script)), raster image data (JPEG and TIFF) and vector image data (SVG (Scalable Vector Graphics)). The variable object group (133) does not need to be stored in the external memory (130) of the printer controller (12B). The variable object group (133) may be stored in a remote database or a share file system.

The memory (140) temporarily memorizes the page image (141) created in the image synthesizing section (122) and the raster images (142,143) generated in the image generating section (121). These data are transmitted to the external memory (130) and the printer engine I/F (125) by the control section (120).

The page image (141) is an image that illustrates the contents of the page to be printed. The page image (141) is transmitted to the printer (13A or 13B) by the control section (120).

The reusable image (142) is a raster image to be used a plurality of times in a document, and is generated by the image generating section (121). The fact that the image is reusable is described in the layout information (132). The reusable image (142) is cached until the creation of the page image for all the pages is completed.

The non-reusable image (143) is a raster image to be used only few times (for example, one time) in a document, and is generated by the image generating section (121). For example, in the case of direct mail, a customer name and a customer address can be included. The fact that the image is non-reusable is indicated in the layout information (132). After the use, the non-reusable image is promptly eliminated from the memory (140).

The common coding table (144) is a common color map by which a color number (index value) and actual color component value (coordinate value on a color space) are defined. The size of a color map shall be defined in advance by the limited numbers of colors (256 colors or 65536 colors) from which the effect of the image synthesis method of this embodiment of the present invention can be expected. The common coding table (144) is held in the memory (140) until the creation for all pages is completed. The concrete contents of the common coding table are illustrated in FIG. 6.

The above-mentioned image synthesizing section (122), common coding section (123) and common decoding section (124) may be configured as hardware. A configuration is also possible where an image synthesis program to have a computer function the image synthesizing section (122), the common coding section (123) and the common decoding section (124). The computer can be configured so that the image synthesis program may operate on the control section (120). Hereafter, the image synthesis method of this embodiment of the present invention will be described.

### [The Entire Flow]

Firstly, the entire flow of the variable print system of this embodiment of the present invention will be described in reference to the flow chart of FIG. 2.

A user creates variable print data using the application software installed in the client PC (11A, 11B, or 11C). The created variable print data is stored in the external memory (130) of the printer controller (12A or 12B) through the communication line (14).

Next, in Step S101, the control section (120) of the printer controller (12A or 12B) acquires the layout information (132) from the variable print data (131) stored in the external memory (130), and generates the reusable images (142) included in the variable object group (133) from the layout information (132) with the image generating section (121).

Next, in Step S102, after the control section (120) compresses the generated reusable images (142) via the common coding section (123), the generated reusable images (142) will be cached in the memory (140). The details of this common coding process will be described later.

Next, in Step S103, the control section (120) acquires the layout information for one page, and instructs the image synthesizing section (122) of page layout for one page. The image synthesizing section (122) synthesizes an image based on the layout information. In that case, the synthesis is performed in a compressed state. The details of this image synthesis process will be described later.

Next, in Step S104, the control section (120) decodes the page image (141) having the page layout completed with the common decoding section (124), and sends the page image (141) to the printer (13B) via the printer engine I/F (125). The details of this common decoding process will be described later.

In Step S105, the control section (120) determines whether the printout for all pages has been completed, and returns to Step S103 in case when the printout for all pages is not completed. Then, the above-mentioned process is repeated until the printout of all the pages is completed.

The above-mentioned flow illustrated the case where the common decoding process (S104) was performed by the common decoding section (124) of the printer controller (12B). However, in case when the hardware on the printer engine I/F (125) or the printer (13B) is able to decode data, the common decoding section (124) can be omitted.

### [Common Coding Process]

Next, the details of the common coding process of Step S102 will be described in reference to the flow chart of FIG. 3. This common coding process is executed by the common coding section (123) in accordance with the control of the control section (120).

Firstly, one of the data of the raster images (142, 143) specified by the control section (120) is read in Step S102a.

Next, common coding is performed while scanning all the pixels in the read image. A targeted pixel shall move from the starting point (usually upper left) of an image in order of the main scanning direction (horizontal)/the sub-scanning direction (vertical). Concretely, the color component value of the targeted pixel is read in Step S102b. Whether the color component value of the read targeted pixel is already registered in the common coding table (144) is determined in Step S102c. In case when the color component value is not registered, the color component value is registered into the common coding table (144). In the common coding table (144), the registration is performed after the sequential color numbers (0—(size of the common coding table—one)), which will be a new code, are assigned.

Next, a code (color number) corresponding to the color component value is acquired from the common coding table (144) in Step S102d.

Next, the acquired code (color number) is written in as compressed data in Step S102e.

Whether the coding of all of the data of the specified raster images (142, 143) has been completed or not is determined in Step S102f. Then, the above-mentioned process is repeated until the coding of all of the data of the specified raster images (142, 143) completes. A concrete process image of this common coding process is illustrated in FIG. 7.

In FIG. 3, whether the color component value is registered in the common coding table in a pixel unit is determined. However, as it is easy to understand when imagining the text and the solid coated section, there is a very high possibility that the targeted pixel and a vicinity pixel surrounding the targeted pixel are set up in the same color. Focusing on this point, the common coding process may be configured to perform the access to the common coding table only in the case when the color component value of the targeted pixel and the color component value of the already scanned vicinity pixels (the left-hand of the targeted pixel, or the pixel right above) differ after the comparison of the two color component values. Thereby, the high efficiency of process can be attained. This technique may also be applied to the common decoding process and the application determining process, which will be described henceforth.

### [Compression Synthesis Process]

Next, the detail of the compression synthesis process of Step S103 will be described in reference to the flow chart of FIG. 4. This compression synthesis process is executed by the image synthesizing section (122) in accordance with the control of the control section (120).

Firstly, the layout information of one page received from the control section (120) is read in at Step S103a.

Next, the layout information for one object within the layout information of one page is read in at Step S103b.

Next, whether the object to be laid out is either the reusable image (142) or the non-reusable image (143) is determined in Step S103c. In case when the object to be laid out is the reusable image (142), a corresponding image is read from a cache in Step S103d, and synthesis (replacement of the color number) is performed in the compressed state without decoding in Step S103e. On the other hand, in case when the object to be laid out is the non-reusable image (143), an image is generated by the image generating section (121) in Step S103g, and after being compressed via the common coding section (123) in Step S103h, synthesis (replacement of the color number) is performed in the compressed state in Step S103e.

Next, the above-mentioned process is repeated until it is determined that the synthesis process of all objects indicated in the layout information of one page in Step S103f is completed. A concrete processing image of this compression synthesis process is illustrated in FIG. 8.

### [Common Decoding Process]

Next, the detail of the common decoding process of Step S104 will be described in reference to the flow chart of FIG. 5. This common decoding process will be executed by the common coding section (123) in accordance with the control by the control section (120).

Firstly, the page image (141), which was specified by the control section (120) and has been compressed and synthesized, is read in Step S104a.

Next, all of the pixels of the read page image (141) are decoded while scanning all the pixels in Step S104b.

Next, the color component value corresponding to the code (color number) of the read targeted pixel is acquired from the common coding table (144) in Step S104c.

Next, the acquired color component value is written in as decoded data in Step S104d.

The above-mentioned process is repeated until it is determined that the decoding of all pixels of the specified page image (141) is completed in Step S104e. The concrete processing image of this common decoding process is illustrated in FIG. 9.

Thus, in this embodiment of the present invention, the layout information (132) is acquired from the variable print data (131). The reusable image (142) included in the variable object group (133) is generated from the layout information (132). The color component value (coordinate value on a color space) of each pixel of the reusable image (142) is converted into the color number (index value) by using the common coding table (144), and is compressed. The compressed data is cached. The image is synthesized in the compressed state at the time of image synthesis. Since the color number of each pixels of the image compressed using the above-mentioned common coding table (144) is converted into the color component value and extracted or decompressed at the time of decoding process, the image can be efficiently synthesized while controlling the degradation of the image.

### SECOND EMBODIMENT

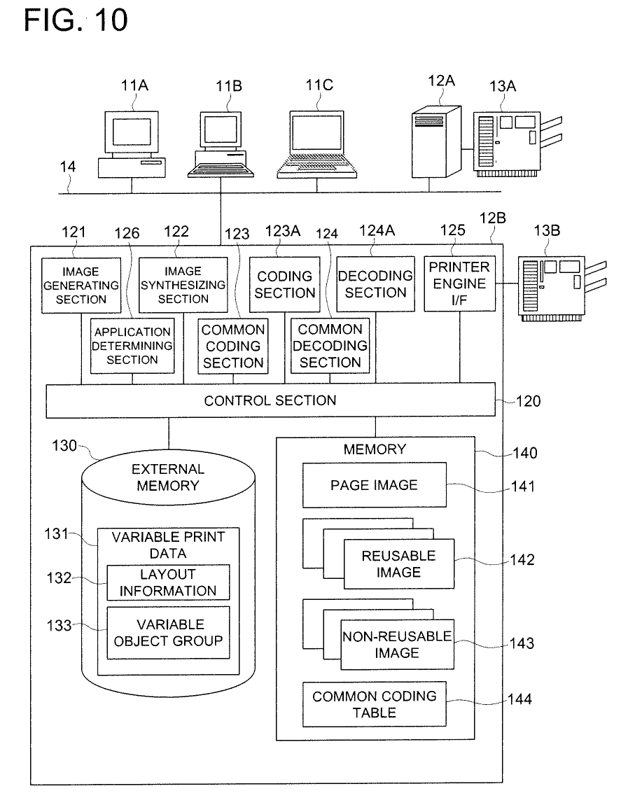

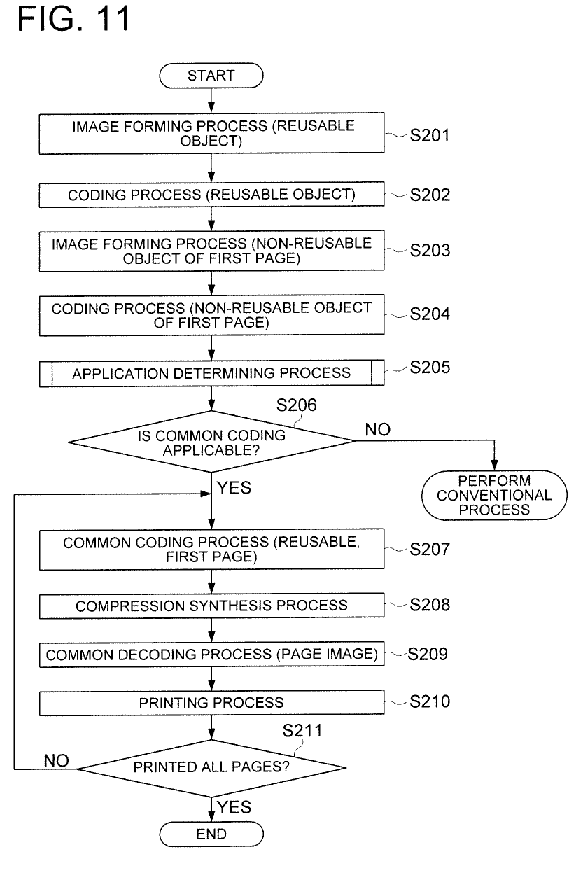

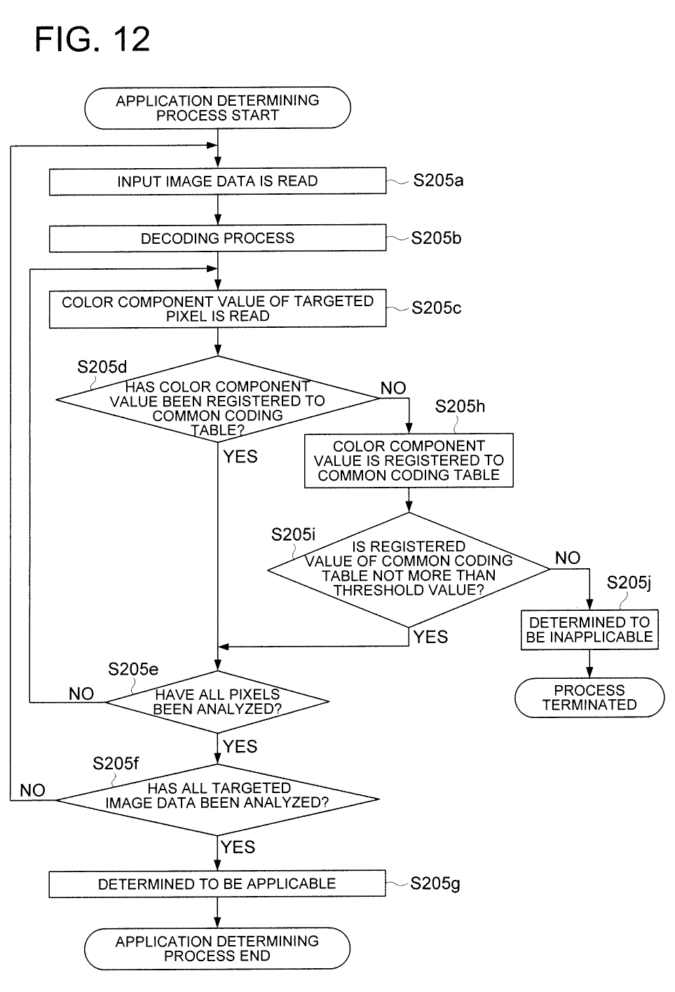

Next, the image synthesis method, the print system and the image synthesis program related to a second embodiment of the present invention will be described in reference to FIGS. 10-12. FIG. 10 is a diagram illustrating a configuration of the variable print system of this embodiment of the present invention. FIG. 11 is a flow chart illustrating the entire flow of the variable print system of this embodiment of the present invention. FIG. 12 is a flow chart illustrating the application determining process in the printer controller.

In the above-mentioned first embodiment, the size of the common coding table (144) was set up with the fixed value in advance assuming that the image synthesis method, the print system and the image synthesis program will be used in the environment where only printing the document, such as a ledger sheet and an invoice, in which the numbers of colors used are limited. However, needless to say, there is a possibility that the printed material, in which natural pictures, such as a photograph, are abundantly used, is inputted. In that case, there is a possibility that the numbers of colors used may exceed the size of the common coding table (144).

Accordingly, in this embodiment of the present invention, before performing the synthesis process of a head page, a process of determining applicability of the common coding is performed based on the numbers of colors used for all of the reusable images (142) and non-reusable image (143) to be laid out in the head page. In case when the common coding is applicable, the common coding process will be performed. In case when the common coding is not applicable, the conventional process will be performed. The reason why the target of application determination of the non-reusable image (143) is set only to the head page is that as a characteristic of the variable printing, it is common to print the pages by substituting the data of the same attribution (text, illustration and image) at the same place in the following pages.

FIG. 10 illustrates an example of the variable print system of this embodiment of the present invention. In this embodiment of the present invention, the coding section (123A), the decoding section (124A) and the application determining section (126) are provided in the printer controllers (12A, 12B) of FIG. 1. Hereafter, sections that are different from the system configuration of first embodiment will be described.

The coding section (123A) is used when the reusable image (142) and the non-reusable image (143) of the head page are cached in the memory (130).

The decoding section (124A) is used when decoding the cached reusable image (142) and non-reusable image (143) of the head page.

The application determining section (126) is arranged to determine whether the common coding is applicable or not by comparing the size of the predetermined threshold value to the numbers of colors used of the reusable image (142) and the non-reusable image (143) of the head page with instructions of the control section (120). The limited numbers of colors, from which the effect of the image synthesis method of this embodiment can be expected, may be arbitrary set to the threshold value.

The image synthesizing section (122), the common coding section (123), the common decoding section (124), the coding section (123A), the decoding section (124A) and the application determining section (126) may be configured by hardware. A configuration is also possible where an image synthesis program is configured to allow the computer function as the image synthesizing section (122), the common coding section (123), the common decoding section (124), the coding section (123A), the decoding section (124A) and the application determining section (126). This image synthesis program may be configured to operate in the control section (120).

### [The Entire Flow]

Next, the entire flow of the variable print system of this embodiment of the present invention will be described in reference to the flow chart of FIG. 11.

A user creates the variable print data using the application software installed in the client PC (11A, 11B, or 11C). The created variable print data is stored in the external memory (130) of the printer controller (12B) through the communication line (14).

Next, in Step S201, the control section (120) of the printer controller (12A or 12B) acquires the layout information (132) from the variable print data (131) stored in the external memory (130). Then, the control section (120) of the printer controller (12B) generates the reusable images (142) included in the variable object group (133) from the layout information (132) with the image generating section (121).

Next, in Step S202, after the generated reusable images (142) are compressed via the coding section (123A), the control section (120) caches the generated reusable images (142) to the memory (140).

Next, in Step S203, the control section (120) acquires the layout information of one page. The control section (120) generates only the non-reusable images (143) of the head page included in the variable object group (133) with the image generating section (121).

Next, in Step S204, after the generated non-reusable images (143) are compressed via the coding section (123A), the control section (120) caches the generated non-reusable images (143) of the head page to the memory (140).

Next, in Step S205, the control section (120) instructs the application determining section (126) to perform the application determining of the common coding based on the reusable images (142) cached in the memory (130) and the non-reusable images (143) of the head page. The details of this application determining process will be described later.

In case when the common coding was determined to be applicable in Step S206, the control section (120) re-caches the reusable images (142) and the non-reusable images (143) of the head page into the memory (140) after the re-usable images (142) and the non-reusable images (143) of the head page are compressed via the common coding section (123) in Step S207. The process of the subsequent steps S208-S211 is the same as Steps S103-S106 of the first embodiment. On the other hand, in case when the common coding is determined to be not applicable, the conventional process will be performed.

### [Application Determining Process]

Next, the details of the application determining process of Step S205 will be described in reference to the flow chart of FIG. 12. This application determining process is executed by the application determining section (126) in accordance with the control of the control section (120).

Firstly, one raster image data being application determination target specified by the control section (122) is read in Step S205a.

Next, in case when the read raster image data is compressed by the coding section (123A), the raster image data will be decoded via the decoding section (124A) in Step S205b.

Next, the determination of applicability of the common coding process will be performed while extracting the color component values of all pixels in the read image. Concretely, the color component value of the targeted pixel is read in Step S205c. In Step S205d, whether the color component value of the targeted pixel is already registered to the common coding table or not is determined. In case when the color component value of the targeted pixel is not registered, the color component value is registered into the common coding table in Step S205h. Next, the sizes of the number of the currently registered color component values in the common coding table and the predetermined threshold value are compared in Step S205i. When the number of registered color component values in the common coding table exceeds the threshold value, the common coding is determined to be not applicable in Step S205j and the process ends immediately.

On the other hand, in case when the number of registered color component values in the common coding table is not more than the threshold value, whether the analysis of all pixels has been completed or not is determined in Step S205e. When the analysis of all pixels is determined not to be complete, the process returns to Step S205c. When analysis of all pixels is determined to be complete, whether the analysis of all targeted raster image data has been completed or not is determined in Step S205f. When the analysis of all targeted raster image data is determined not to be complete, the process returns to Step S205a. When the analysis of all targeted raster image data is determined to be complete, the common coding is determined to be applicable in Step S205g and the application determining process ends.

Thus, the predetermined threshold value is compared with the numbers of colors used for the reusable image (142) and non-reusable image (143) of the head page. The printing process may be executed properly even when the natural image, such as photograph, is abundantly used in the printing material by determining that the common coding process is applicable when the numbers of colors used is not more than the threshold value.

### Third Embodiment

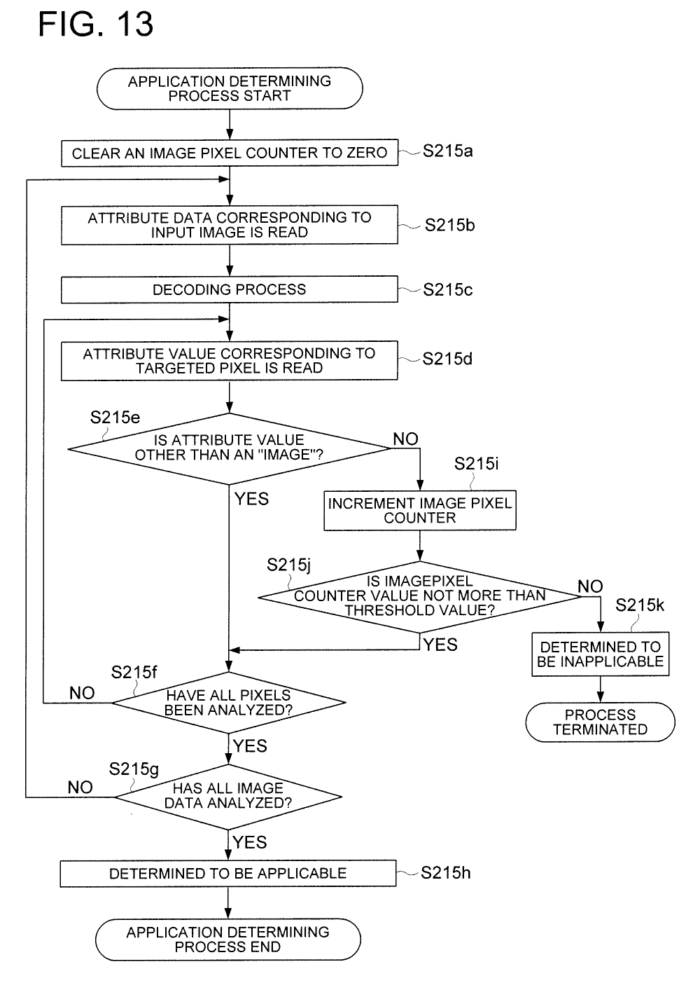

Next, the image synthesis method, the print system and the image synthesis program related to a third embodiment of the present invention will be described in reference to FIG. 13. FIG. 13 is a flow chart illustrating the application determining process of the printer controller of this embodiment of the present invention.

In the above mentioned second embodiment, the numbers of colors used of the reusable images (142) and of the non-reusable images (143) of the head page were compared with the predetermined threshold value at the time when determining the applicability of the common coding process. However, other techniques can also be used.

For example, in an image generating device (RIP (Raster Image Processor)), there is an image generating device that is capable of outputting, for each pixel, the attribute data along with the color component values, such as CMYK values. As the outputted attribute value, three classifications of texts, graphics and images (photographic images) are common. Among them, a text portion and a graphics portion have a high possibility that the numbers of colors used, such as black monochrome and solid coating, are very little. Conversely, an image portion has a high possibility that the numbers of colors used is very large. Focusing on this point, whether the common coding process is applicable or not is determined based on the quantity of pixels equivalent to the image in this embodiment of the present invention. When this embodiment of the present invention is compared with the above mentioned second embodiment, the verification of the color component value being registered in the common coding table will not be needed. Therefore, in this embodiment of the present invention, the application determination may be performed faster. The concrete contents of process of the application determination will be described below.

### [Application Determining Process]

The details of the application determining process will be described in reference to the flow chart of FIG. 13. This application determining process is executed by the application determining section (126) in accordance with control of the control section (120).

Firstly, the image pixel counter that is preliminary provided in the printer controller (12B) is cleared to be zero in Step S215a.

Next, in Step S215b, one attribute data corresponding to the raster image data being the target of the common coding specified by the control section (120) is read. Here, it is assumed that the attribute data is configured with the same quantity of pixels as the raster image data.

Next, in Step S215c, in case when the read attribute data is compressed by the coding section (123A), the attribute data is decoded via the decoding section (124A).

Next, applicability of common coding is determined while extracting the attribute values of all pixels of the read attribute data in order. Concretely, in Step S215d, the attribute value corresponding to the targeted pixel is read in. In Step S215e, whether the attribute value of the targeted pixel read in is the “image” or not is determined. In case the attribute value of the targeted pixel read in is the “image,” an image pixel counter increments in Step S215i. Next, the sizes of the predetermined threshold value and of the image pixel counter are compared in Step S215j. When the number of image pixel counter exceeds the threshold value, the common coding is determined not to be applicable in Step S215k and the process ends immediately.

On the other hand, in case when the number of image pixel counter is not more than the threshold value, the analysis of all pixels is determined to be complete in Step S215f. When the analysis of all pixels is not completed, the process returns to Step S215d. Then, whether the analysis of all targeted raster image data is complete or not is determined in Step S215g. When the analysis of all targeted raster image data is not complete, the process returns to Step S215b. Then, the common coding is determined to be applicable in Step S215h and the application determining process ends.

Thus, the quantity of pixels of the attribute value indicating the “image” and the predetermined threshold value are compared. The verification of the color component value being registered in the common coding table becomes unnecessary and the application determination can be performed faster by determining that the common coding is applicable when the quantity of pixels is not more than the threshold value.

### Fourth Embodiment

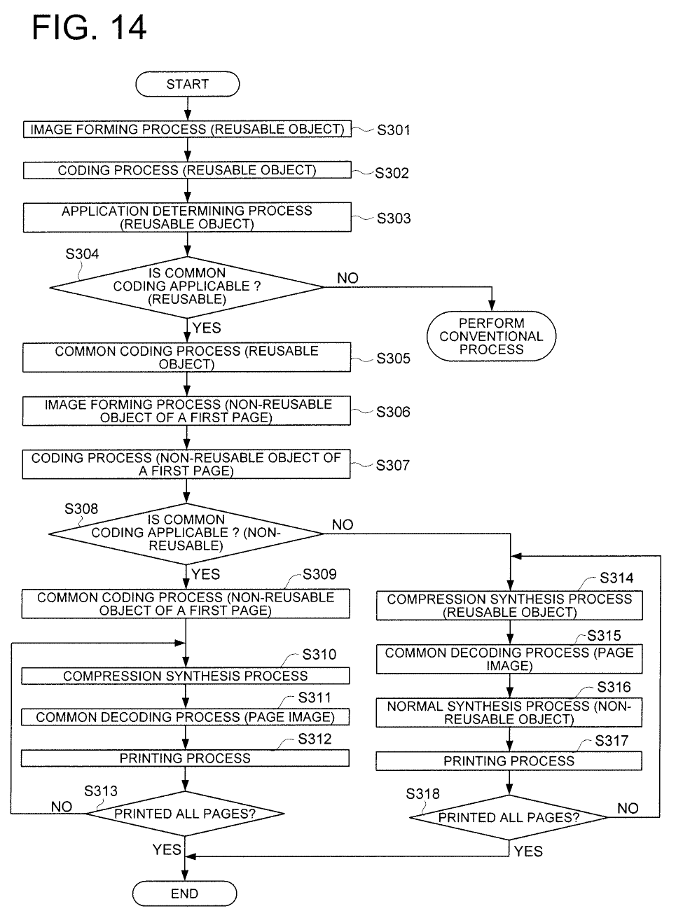

Next, the image synthesis method, the print system and the image synthesis program related to a fourth embodiment of the present invention will be described in reference to FIG. 14. FIG. 14 is a flow chart illustrating the entire flow of the variable print system of this embodiment of the present invention.

In the above-mentioned second and third embodiments, the application determination was performed to the pixel data of both of the reusable objects and the non-reusable objects. However, there is a possibility that printing materials, which are mainly configured by the headline texts, such as “bargain” and “price busters”, or the background of logo or illustration as reusable objects, for example, POP, and in which pictures of merchandises are abundantly used as the non-reusable objects, are inputted. In this case, there is a high possibility that the common coding process is applicable to the reusable object portions and not applicable to the non-reusable object portions.

Accordingly, in this embodiment of the present invention, the application determination of the common coding process is individually performed to each of the reusable objects and the non-reusable objects. That is, the processing time for performing the synthesis process to the reusable object portions can be shortened by performing the common coding process to the reusable object portions and performing the conventional process to the non-reusable object portions (namely, perform hybrid processing) when the common coding process is only applicable to the reusable objects. The concrete contents of the processing are described below.

### [The Entire Flow]

The entire flow of the variable print system of this embodiment of the present invention will be described in reference to the flow chart of FIG. 14.

A user creates the variable print data using the application software installed in the client PC (11A, 11B, or 11C). The created variable print data is stored in the external memory (130) of the printer controller (12A or 12B) through the communication line (14).

Next, in Step S301, the control section (120) acquires the layout information (132) from the variable print data (131) stored in the external memory (130). The control section (120) generates the reusable images (142) included in the variable object group (133) from the layout information (132) with the image generating section (121).

Next, in Step S302, after the generated reusable images (142) are compressed via the common coding section (123), the control section (120) caches the generated reusable images (142) to the memory (140).

Next, in Step S303, the control section (120) instructs the application determining section (126) to perform the application determination of the common coding based on the reusable images (142), which is cached to the memory (140). When the common coding is determined to be applicable in Step S304, the reusable images (142) are re-cached into the memory (140) after being compressed via the common coding section (123) in Step S305. When the common coding is determined to be not applicable, the conventional process is performed.

Next, in Step S306, the control section (120) acquires the layout information of one page. The image generating section (121) generates the non-reusable images (143) of the head page included in the variable object group (133).

Next, in Step S307, the control section (120) caches the generated non-reusable images (143) of the head page into the memory (140) after the generated non-reusable images (143) of the head page are compressed via a coding section (123A).

Next, the control section (120) instructs the application determining section (126) to perform the application determination of the common coding based on the non-reusable images (143) of the head page, which are cached in the memory (140). When the common coding is determined to be applicable in Step S308, the non-reusable images (143) of the head page is re-cached into the memory (140) after the non-reusable images (143) of the head page are compressed via the common coding section (123) in Step S309. The process of the subsequent steps S310-S313 is the same as Steps S103-S106 of the first embodiment.

On the other hand, in case when the common coding is determined to be inapplicable in Step S308, the control section (120) acquires the layout information of one page. Then in Step S314, the control section (120) instructs the image synthesizing section (122) to perform the page layout with compression synthesis only to the reusable objects for one page.

Next, in Step S315, the control section (120) instructs the common decoding section (124) to decode the page image (141) to which the page layout of only reusable objects is completed. In Step S316, the control section (120) instructs the image synthesizing section (122) to perform page layout with normal synthesis only to the non-reusable objects for one page.

Lastly, in Step S317, the control section (120) sends the page image (141), in which the page layout has been completed, to the printer (13B) via the printer engine I/F (125).

In Step S318, the control section (120) determines whether the printout of all pages has been completed. When the printout of all pages is not completed, the process returns to Step S314. When the printout of all pages has been completed, the process ends.

Thus, the time involved in the synthesis process of the reusable object portions can be shortened by performing the application determining of the common coding process to each of the reusable objects and non-reusable objects.

In each of the above-mentioned embodiments, the color component value (coordinate value on a color space) and the color number (index value) are respectively represented by 32 bits and 8 bits; however, the concrete numbers of the bits are not limited thereto, insofar as the number of bits of the color number is smaller than the number of bit of the color component value. In each of the above-mentioned embodiments, a case in which the printer controller generates the rasterized image and executes compression, synthesis and expansion of this rasterizing image were described. However, the present invention is not limited to the above-mentioned embodiments. It may be configured so that all or a part of generating, compressing, synthesizing and expanding of the rasterized image may be performed in the printer. The system configuration may have a function of the printer controller included in the printer.

According to the image synthesis method, the print system and the image synthesis program of the preferred embodiments of the present invention, the unnecessary degradation of an image at the time of decoding can be prevented, and the image can be efficiently synthesized.

The reasons are that a plurality sets of image data to be the target of synthesis are coded (compressed) by fixed-length lossless compression form in a pixel unit with using the common coding table, these sets of coded image data are synthesized in a pixel unit and the image data is decoded (decompressed) in a pixel unit using the above mentioned common coding table after the synthesis.

The present invention can be used for an image forming apparatus and a printer controller, such as a copying machine and a multi function peripheral.

What is claimed is:

1. An image synthesis method comprising the steps of:
executing a lossless compression of first image data of a first image in a pixel unit by utilizing a table which correlates coordinate values expressed in m bits in a color space to index values expressed in n bits that is smaller than the m bits;
executing a lossless compression of second image data of a second image in a pixel unit by utilizing the table used to execute the lossless compression of the first image data;
generating compressed synthetic image data by synthesizing the compressed first image data and the compressed second image data in a pixel unit; and
decompressing the compressed synthetic image data in a pixel unit by utilizing the table to generate synthetic image data in which each pixel of the synthetic image data is expressed as a coordinate value in the color space.

2. The image synthesis method of claim 1, wherein the table is established in the steps of executing the lossless compressions of the first image data of the first image and the second image data of the second image in a pixel unit.

3. The image synthesis method of claim 1, further comprising a step of comparing the number of the index values to be used for expressing target images of synthesis with a predetermined threshold value, wherein the lossless compressions, the generation of the compressed synthetic image data, and the decompression of the compressed synthetic image data in a pixel unit are executed in cases where the number of the index values is not greater than the threshold value.

4. The image synthesis method of claim 1, further comprising a step of comparing the number of pixels each of which has a specific attribute value in target images of synthesis with a predetermined threshold value, wherein the lossless compressions, the generation of the compressed synthetic image data, and the decompression of the compressed synthetic image data in a pixel unit are executed in cases where the number of pixels having the specific attribute value is not greater than the threshold value.

5. The image synthesis method of claim 3, wherein the target images of synthesis comprises at least one reusable image and at least one non-reusable image for image synthesis, wherein
the comparison of the number of the index values with the predetermined threshold value is executed for each of the reusable image and the non-reusable image.

6. The image synthesis method of claim 4, wherein the target image of synthesis comprises at least one reusable image and at least one non-reusable image for image synthesis, wherein
the comparison of the number of pixels each of which has the specific attribute value with the predetermined threshold value is executed for each of the reusable image and the non-reusable image.

7. A printing system for printing images by synthesizing a plurality of images, comprising:
a coding section which executes a lossless compression of first image data of a first image in a pixel unit by utilizing a table correlating coordinate values expressed in m bits in a color space to index values expressed in n bits that is smaller than the m bits, and which executes a lossless compression of second image data of a second image in a pixel unit by utilizing the table used to execute the lossless compression of the first image data;
an image synthesizing section which generates compressed synthetic image data by synthesizing the compressed first image data and the compressed second image data in a pixel unit; and
a decoding section which decompresses the compressed synthetic image data in a pixel unit by utilizing the table, and generates synthetic image data in which each pixel of the synthetic image data is expressed as a coordinate value in the color space.

8. The printing system of claim 7, wherein the table is established in the course of executing the lossless compressions of the first image data of the first image and the second image data of the second image in a pixel unit.

9. The printing system of claim 7, further comprising an application determining section which compares the number of the index values to be used for expressing target images of synthesis with a predetermined threshold value, and determines that the lossless compressions, the generation of the compressed synthetic image data, and the decompression of the compressed synthetic image data in a pixel unit are applicable in cases where the number of the index values is not greater than the threshold value.

10. The printing system of claim 7, further comprising an application determining section which compares the number of pixels each of which has a specific attribute value in target images of synthesis with a predetermined threshold value, and determines that the lossless compressions, the generation of the compressed synthetic image data, and the decompression of the compressed synthetic image data in a pixel unit are applicable in cases where the number of pixels having the specific attribute value is not greater than the threshold value.

11. The printing system of claim 9, wherein the target images of synthesis comprises at least one reusable image and at least one non-reusable image for image synthesis, wherein the application determining section compares the number of the index values with the predetermined threshold value for each of the reusable image and the non-reusable image.

12. The printing system of claim 10, wherein the target image of synthesis comprises at least one reusable image and at least one non-reusable image for image synthesis, wherein the application determining section compares the number of pixels each of which has a specific attribute value with the predetermined threshold value for each of the reusable image and the non-reusable image.

13. A computer-readable storage medium stored therein an image synthesis program which runs in a printing system for printing images by synthesizing a plurality of images to allow a computer to function as the sections comprising:
a coding section which executes a lossless compression of first image data of a first image in a pixel unit by utilizing a table which correlates coordinate values expressed in m bits in a color space to index values expressed in n bits that is smaller than the m bits, and which executes a lossless compression of second image data of a second image in a pixel unit by utilizing the table used to execute the lossless compression of the first image data;
an image synthesizing section which generates compressed synthetic image data by synthesizing the compressed first image data and the compressed second image data in a pixel unit; and
a decoding section which decompresses the compressed synthetic image data in a pixel unit by utilizing the table, and generates synthetic image data in which each pixel of the synthetic image data is expressed as a coordinate value in the color space.

14. The computer-readable storage medium of claim 13, wherein the table is established in the course of executing the lossless compressions of the first image data of the first image and the second image data of the second image in a pixel unit.

15. The computer-readable storage medium of claim 13, wherein the program further allows the computer to function as an application determining section which compares the number of the index values to be used for expressing target images of synthesis with a predetermined threshold value, and determines that the lossless compressions, the generation of the compressed synthetic image data, and the decompression of the compressed synthetic image data in a pixel unit are applicable in cases where the number of the index values is not greater than the threshold value.

16. The computer-readable storage medium of claim 13, wherein the program further allows the computer to function as an application determining section which compares the number of pixels each of which has a specific attribute value in target images of synthesis with a predetermined threshold value, and determines that the lossless compressions, the generation of the compressed synthetic image data, and the decompression of the compressed synthetic image data in a pixel unit are applicable in cases where the number of pixels having the specific attribute value is not greater than the threshold value.

17. The computer-readable storage medium of claim 15, wherein the target images of synthesis comprises at least one reusable image and at least one non-reusable image for image synthesis, wherein the application determining section compares the number of the index values with the predetermined threshold value for each of the reusable image and the non-reusable image.

18. The printing system of claim 16, wherein the target images of synthesis comprises at least one reusable image and at least one non-reusable image for image synthesis, wherein the application determining section compares the number of pixels each of which has a specific attribute value with the predetermined threshold value for each of the reusable image and the non-reusable image.
